(19) United States
(12) Patent Application Publication
(10) Pub. No.: US 2002/0039888 A1
(43) Pub. Date: Apr. 4, 2002

(54) Wireless communication device

(75) Inventor: Norio Hama, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 09/961,065

(22) Filed: Sep. 24, 2001

(30) Foreign Application Priority Data
Sep. 29, 2000 (JP) 2000-300467

(51) Int. Cl. H04B 1/10

(52) U.S. Cl. 455/63; 455/425; 455/118

(57) ABSTRACT

In a wireless communication device which performs a wireless communication on an internal power supply without use of a commercial power, the period of a disturbance electromagnetic wave from a microwave oven or the like is accurately detected to avoid any effect of the disturbance electromagnetic wave.

A receiving circuit 3 and a transmitting circuit 4 are connected to a transmitting/receiving antenna 1 through a transmitter/receiver switching circuit 2 and a frequency synthesizer 15 is also provided. An RSSI signal detected by the receiving circuit 3 is compared by a comparator 29 with a frequency-divided signal supplied by a variable frequency dividing circuit 28 which performs a frequency dividing operation on a master clock with a gradually varying frequency dividing ratio. When the two signals coincide, a period determination circuit 30 supplies a radiation period signal synchronized with the disturbance wave to a received data processor 21, a frequency hopping controller 22, a transmission data processor 23, and a power supply controller 25, so that a control signal to keep the communication connection established can be shifted into a frequency band with no effect of the disturbance wave and data transmission/reception can be performed during a period of time while no disturbance wave is radiated.

### BACKGROUND OF THE INVENTION

1. Field of the Invention

The present invention relates to an improved wireless communication device which is, for example, a portable device driven by an internal power supply to perform a wireless transmission/reception in, for example, a 2.4 GHz band.

2. Description of the Related Art

When a portable equipment incorporates a wireless communication system, the wireless system is required to have a power-saving capability and to provide efficient communication by knowing the environmental conditions although the recent wave environment has been deteriorating.

Particularly, the ISM band of 2.4 GHz has been exploited by various industrial equipments and thus, some industrial equipments used by others may act as obstacles originating undesired waves. Among others, a microwave oven, in spite of its long history, radiates an undesired wave of a wider band within the 2.4 GHz band and therefore, it is necessary to detect an electromagnetic wave radiation period of the microwave oven in order to avoid interference from the microwave oven.

To detect the electromagnetic wave radiation period of the microwave oven, for example, prior systems as described in the Japanese Patent Application Laid-Open No. 9-64827 (hereinafter referred to as a first prior art), the Japanese Patent Application Laid-Open No. 11-205251 (hereinafter referred to as a second prior art), and the Japanese Patent Application Laid-Open No. 11-177531 (hereinafter referred to as a third prior art) have been well known.

In the first prior art, a wireless LAN device for an SS-type wireless LAN using the 2.45 GHz band has been disclosed, which detects a stop half cycle from the alternating current polarity of a commercial power and performs a wireless transmission only during the stop half cycle in order to avoid any disturbance wave from a microwave oven which uses the same band, since a magnetron of the microwave oven is synchronized with the frequency of the commercial power to oscillate within its positive or negative half cycle and to stop within the other half cycle.

In the second prior art, a wireless communication method has been disclosed, which ensures that a device is capable of performing a wireless communication in order to reduce possible interference by electromagnetic waves from a plurality of microwave ovens, by detecting output timings of the electromagnetic waves from the plurality of microwave ovens and controlling the output timing of at least one of the microwave ovens so that a difference in time among these output timings is reduced.

In the third prior art, a wireless communication system has been disclosed, which detects any disturbance wave to a slow frequency hopping spread spectrum communication within any one wireless zone, and then causes a master station within the wireless zone to notify a communication management server of it through a wired system and to receive a notification from the communication management server to the master station, so that a hopping pattern to be used by that master station and its slave station is changed to a first fault-proof hopping pattern using only frequencies in a frequency band which can avoid any disturbance wave as well as a hopping pattern to be used by another parent wireless station and its slave station within another wireless zone adjacent to that wireless zone is changed to a second fault-proof hopping pattern using frequencies outside the frequency band used for the first fault-proof hopping patter, thereby reducing a frequency collision probability.

However, according to the above-mentioned first prior art, the wireless LAN device is powered by the same commercial power supply as that used by the microwave oven and detects the electromagnetic wave radiation period of the microwave oven to control its transmission/reception timings. Thus, since this system involves the commercial power, any wireless communication device which performs a wireless communication with an internal power supply rather than the commercial power cannot detect the electromagnetic wave radiation period of the microwave oven. Moreover, if a communication is to be continued, not only communication data but also a control packet to keep the connection established must be transmitted and disadvantageously, a period of time during which no communication can be made may be produced caused a disadvantage in the light of maintaining the communication state.

According to the second prior art, the electromagnetic wave of the microwave oven can be detected based on a reception-timing signal which is obtained when the level of a received signal is greater than the reference level and then it can be determined whether any electromagnetic wave of the plurality of microwave ovens may cause interference. However, this prior art has no detailed description on how the reception-timing signal affects the communication control.

Moreover, according to the third prior art, when the frequency hopping system detects any disturbance electromagnetic wave which may prevent a wireless communication between the master station and its slave station, the master station accesses the communication management server through a wired system to change to another hopping pattern which can avoid disturbance and then the parent wireless station attempts to reconnect with its slave station for resuming the communication. The connection operation involves a larger power consumption, thus reducing its effective throughput.

### SUMMARY OF THE INVENTION

Therefore, the present invention has been made to solve these problems of the prior arts and it is an object of the present invention to provide a wireless communication device which performs a wireless communication on an internal power supply without use of a commercial power, wherein the periodicity of a disturbance electromagnetic wave from a microwave oven or the like is accurately detected to avoid any effect of the disturbance electromagnetic wave so that the communication can be secured.

It is another object of the present invention to provide a wireless communication device which can reduce its power consumption by keeping the connection established when any disturbance electromagnetic wave is detected and which can further reduce its power consumption by discontinuing the communication when any disturbance electromagnetic wave makes it difficult to continue the communication.

To attain the above objects, a wireless communication device according to claim 1 is a wireless communication device driven by an internal power supply, comprising disturbance component extracting means for extracting from a signal received by a receiving antenna a disturbance component which may affect the device's wireless communication signal, disturbance wave periodicity detecting means for detecting the radiation periodicity by comparing the disturbance component extracted by the above-described disturbance component extracting means with a frequency-divided signal obtained at a gradually varying frequency dividing ratio with respect to a clock signal of a predetermined frequency, and communication control means for performing the exchange of a communication packet during a radiation-free period of time within the radiation periodicity detected by the above-described disturbance wave periodicity detecting means.

A disturbance component which may affect the device's wireless communication signal such as an electromagnetic wave radiated by a microwave oven is extracted by the disturbance component extracting means from a signal received by the receiving antenna, the radiation periodicity of the extracted disturbance component is accurately detected by the disturbance wave periodicity detecting means by comparing the disturbance component with a frequency-divided signal obtained at a gradually varying frequency dividing ratio with respect to a clock signal of a predetermined frequency, and then the exchange of a communication packet is performed by the communication control means during the radiation-free period of time based on the detected radiation periodicity of the disturbance component, so that any effect of the disturbance wave can be avoided to secure the wireless communication.

In the wireless communication device of the present invention, the above-described disturbance wave periodicity detecting means has a frequency dividing circuit for gradually increasing a frequency dividing ratio with respect to an input clock signal of a predetermined frequency and a period determination circuit for determining the period of a disturbance wave by comparing a signal received by a receiving antenna with a frequency-divided signal from the above-described frequency dividing circuit.

The frequency dividing circuit generates a frequency-divided signal with a gradually increased frequency dividing ratio with respect to a clock signal of a predetermined frequency and then the period determination circuit compares the frequency-divided signal with a signal received by the receiving antenna to determine the radiation period accurately synchronized with the disturbance component.

Further, in the wireless communication device of the present invention, the above-described communication control means has communication connection continuing means for shifting the transmission frequency of a control signal to keep the connection established into a preset disturbance-free frequency band to continue the connection when the radiation period of a disturbance wave is detected by the above-described disturbance wave periodicity detecting means.

When the disturbance wave periodicity detecting means detects the radiation period of a disturbance wave, the communication connection continuing means in the communication control means shifts the transmission frequency of a control signal to keep the communication connection established into a frequency band with no effect of the disturbance wave generated by a microwave oven or the like so that the communication connection can be kept established and any reconnect operation which may involve a larger power consumption can be avoided.

Further, in the wireless communication device of the present invention, the above-described communication control means has transmission means for notifying of the presence and period of a disturbance wave any communication partner which cannot detect the presence of the disturbance wave when the above-described disturbance wave periodicity detecting means detects the radiation period of the disturbance wave.

Since any communication partner which cannot detect the presence of a disturbance wave can be notified of the presence and period of the disturbance wave, that communication partner can recognize a fault on the communication line.

Further, in the wireless communication device of the present invention, the above-described device has power control means for controlling the power depending on the radiation period of the disturbance wave detected by the above-described disturbance wave periodicity detecting means.

When the periodicity of a disturbance wave such as an electromagnetic wave generated by a microwave oven is detected by the above-described disturbance wave periodicity detecting means, the communication circuit is powered during the exchange of a communication packet but the power supply to the communication circuit is discontinued during the radiation of the disturbance wave with no communication packet exchanged, so that an unnecessary power consumption can be suppressed.

Further, in the wireless communication device of the present invention, the above-described power control means can be configured to determine whether a communication packet can be transmitted when the radiation period of a disturbance wave is detected by the above-described disturbance wave periodicity detecting means, and to discontinue the power control when the communication packet cannot be transmitted.

An unnecessary power consumption can be suppressed by discontinuing the power control when a disturbance wave hinders the communication packet from being transmitted.

### BRIEF DESCRIPTION OF THE DRAWINGS

FIG. 1 is a block diagram for showing an embodiment of the present invention;

FIG. 2 is an explanatory drawing for showing how the frequencies within the ISM band are used;

FIG. 3 is a drawing for showing the waveform of an electromagnetic wave radiated by a transformer-type microwave oven;

FIG. 4 is a drawing for showing the waveform of an electromagnetic wave radiated by an inverter-type microwave oven;

FIG. 5 is a time chart for showing how the present invention and a prior art are placed into a synchronized state; and

FIG. 6 is a time chart for explaining the operation of the present invention.

### DETAILED DESCRIPTION OF THE PREFERRED EMBODIMENTS

Now, embodiments of the present invention will be described below with reference to the attached drawings.

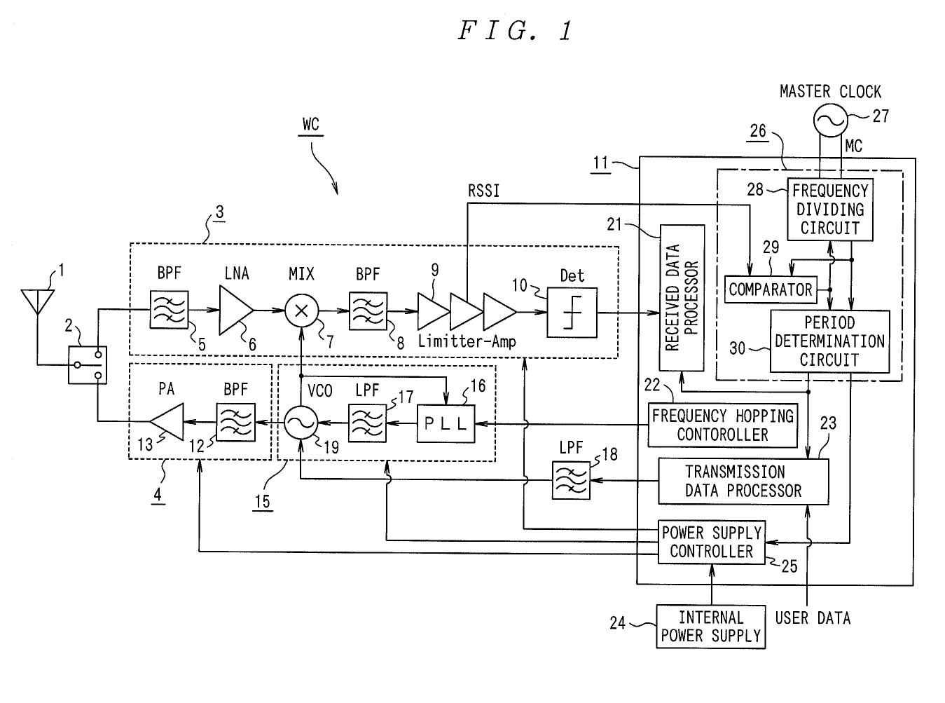

FIG. 1 is a block diagram for showing an embodiment of the present invention and in the figure, WC denotes a portable wireless communication device, in which a transmitting/receiving antenna 1 is connected to a transmitter/receiver switching circuit 2, the receiving-end output terminal of the transmitter/receiver switching circuit 2 is connected to a receiving circuit 3 and the transmitting-end input terminal is connected to a transmitting circuit 4.

The receiving circuit 3 comprises a band-pass filter 5 to which a received signal is supplied by the transmitter/receiver switching circuit 2, a low noise amplifier (LNA) 6 to which a filtered output is supplied by the band-pass filter 5, a mixer 7 which converts an output signal from the low noise amplifier 6 into an intermediate-frequency signal IF by means of a local oscillation signal LO supplied by a frequency synthesizer 15 for frequency hopping as described later, a band-pass filter 8 to which the intermediate-frequency signal IF is supplied by the mixer 7, a limiter amplifier 9 which amplifies an filtered output of the band-pass filter 8, and a detecting circuit 10 to which an amplified output is supplied by the limiter amplifier 9, and then, an RSSI signal representing the level of the received signal from the limiter amplifier 9 is supplied to a baseband signal processor 11 along with received data from the detecting circuit 10.

On the other hand, the transmitting circuit 4 has a band-pass filter 12 to which a transmission signal is supplied the frequency synthesizer 15 and a power amplifier 13 to which a filtered output is supplied by the band-pass filter 12, and then, the transmission signal from the power amplifier 13 is supplied to the transmitting-end input terminal of the transmitter/receiver switching circuit 2.

In addition, the frequency synthesizer 15 has a phase-locked loop (PLL) circuit 16 to which a setpoint signal for setting the frequency hopping is supplied by the baseband signal processor 11, a low-pass filter 17 to which an output signal from the phase-locked loop circuit 16 is supplied, and a voltage-controlled oscillator (VCO) 19 to which an filtered output (that is, a local oscillation signal frequency setting voltage) from the low-pass filter is supplied along with a modulating signal voltage depending on transmission data through a low-pass filter 18 to form a local oscillation signal LO to be supplied to the mixer 7 in the receiving circuit 3 as well as a transmission signal subject to frequency hopping, and then, the local oscillation signal LO from the voltage-controlled oscillator 19 is supplied to the mixer 7 in the receiving circuit 3 without modulation when the wireless communication device WC is in a receiving state and the local oscillation signal LO is modulated with the modulating signal voltage and supplied to the transmitting circuit 4 when the wireless communication device WC is in a transmitting state.

The baseband signal processor 11 comprises a received data processor 21 which processes received data supplied by the receiving circuit 3, a frequency hopping controller 22 which controls the frequency synthesizer 15 to perform a predetermined pattern of frequency hopping within the 2.4 GHz ISM (Industrial Scientific Medical) band, a transmission data processor 23 which processes supplied user data for transmission, a power supply controller 25 which is powered by an internal power supply 24 such as a dry battery(s) or a secondary battery(s) to control the power supply to the receiving circuit 3, the transmitting circuit 4, and the frequency synthesizer 15, and a disturbance wave detector 26 which detects a disturbance wave within the device's transmission frequency band such as an electromagnetic wave generated by a microwave oven based on the RSSI signal from the receiving circuit 3 to determine the period of the wave.

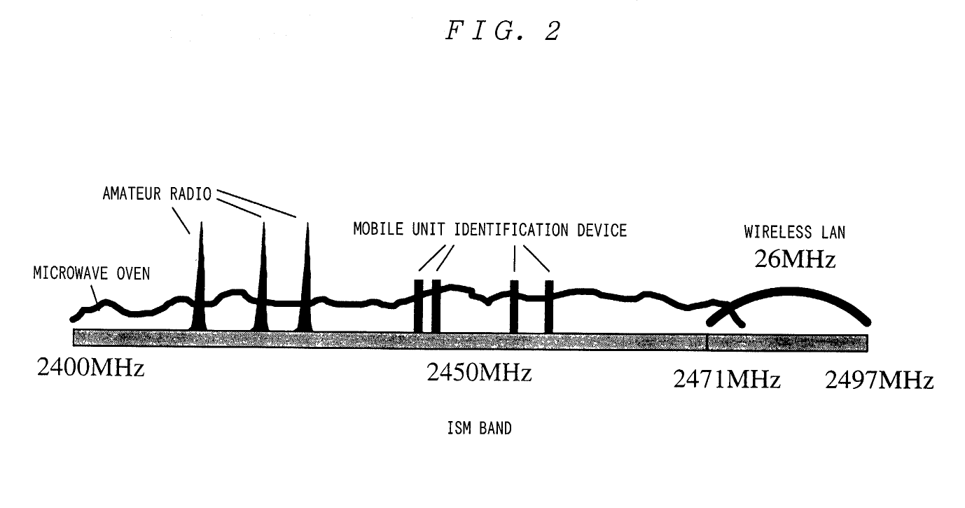

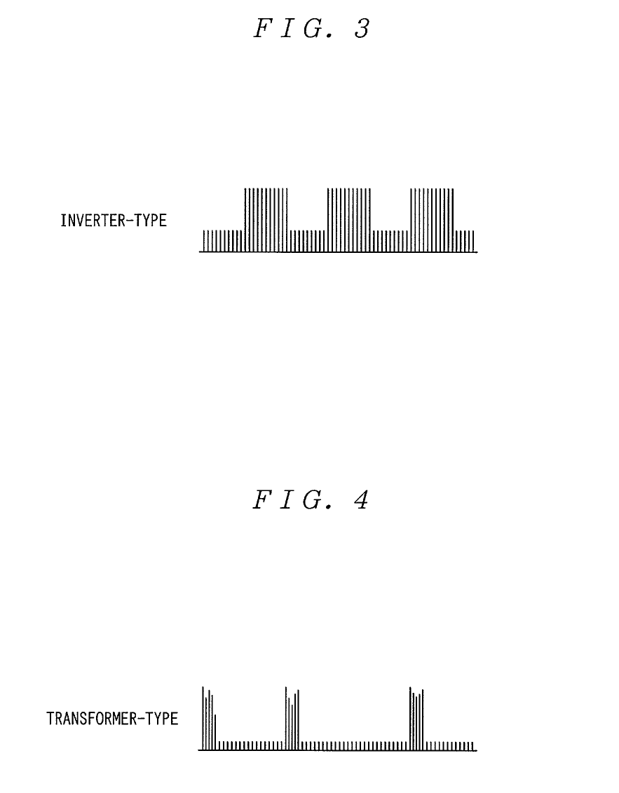

As shown in FIG. 2, within the ISM band, frequencies around 2.425 GHz are allocated to amateur radio stations, those around 2.450 GHz to mobile unit identification devices, and those between 2.471 and 2.497 GHz to wireless LAN applications, respectively. A domestic microwave oven comprises a high-voltage generator, a magnetron for generating waves, and a housing and provides a high-frequency output of 500 to 700 W at frequencies of 2.45±0.05 GHz. Typical microwave ovens are categorized as transformer-type or inverter-type depending on the mechanism for driving a magnetron with high voltages. Since a transformer-type microwave oven raises the commercial power voltage to approximately 4 kV and applies the raised voltage to its magnetron, a burst is generated by a diode at each half cycle in synchronization with the power supply frequency (50 Hz) as shown in FIG. 3. On the other hand, since an inverter-type microwave oven performs switching at approximately 30 kHz through a transistor after full-wave rectification on the commercial power and then raises and applies the commercial power to a magnetron, a high-frequency component contained in a pulsating current during the smoothing is generated by blocking oscillation and switching in synchronization with double the power supply frequency and an output of 2.4 GHz is oscillated in a burst manner at intervals of 10 ms as shown in FIG. 4. In either case, the voltage applied to the magnetron is not kept constant and thus, the oscillation frequency and level are made unstable, thereby generating a disturbance wave over a wider band (2.400 to 2.475 GHz) excluding the wireless LAN band within the ISM band as shown in FIG. 2.

The disturbance wave detector 26 comprises a variable frequency dividing circuit 28 which performs a frequency division on a master clock signal MC supplied by a master clock oscillation circuit 27 with a gradually varying frequency dividing ratio in synchronization with the leading edge of the RSSI signal until a coincidence signal is supplied by a comparator 29 as described later and thereby provides a frequency-divided signal, a comparator 29 which compares the RSSI signal supplied by the limiter amplifier 9 in the receiving circuit 3 with the frequency-divided signal from the variable frequency dividing circuit 28 to provide a coincidence signal when both signals coincide, and a disturbance wave radiation period determination circuit 30 which supplies the frequency-divided output from the variable frequency dividing circuit 28 to the transmission data processor 23 as a radiation period signal when the coincidence signal is provided by the comparator 29.

Upon receipt of the radiation period signal from the disturbance wave radiation period determination circuit 30, the received data processor 21 performs a predetermined data reception process while the radiation period signal is in the ON state. Upon receipt of the radiation period signal from the disturbance wave radiation period determination circuit 30, the transmission data processor 23 performs a predetermined data transmission process while the radiation period signal is in the ON state. As described above, the received data processor 21 and the transmission data processor 23 both perform their own data processing operations while the radiation period signal is in the ON state.

In a normal communication state where no disturbance wave is detected by the detector 26, the frequency hopping controller 22 instructs to perform a frequency hopping operation with a predetermined pattern between certain frequencies according to each communication system within the frequencies of 2400 to 2500 MHz in the ISM band. In a disturbed communication state where any disturbance wave is detected by the disturbance wave detector 26, the frequency hopping controller 22 shifts the transmission frequency of a control signal to secure the connection into a frequency band which may not be affected by any disturbance wave such as an electromagnetic wave generated by a microwave oven.

Now, the operation of the above-mentioned embodiment will be described below.

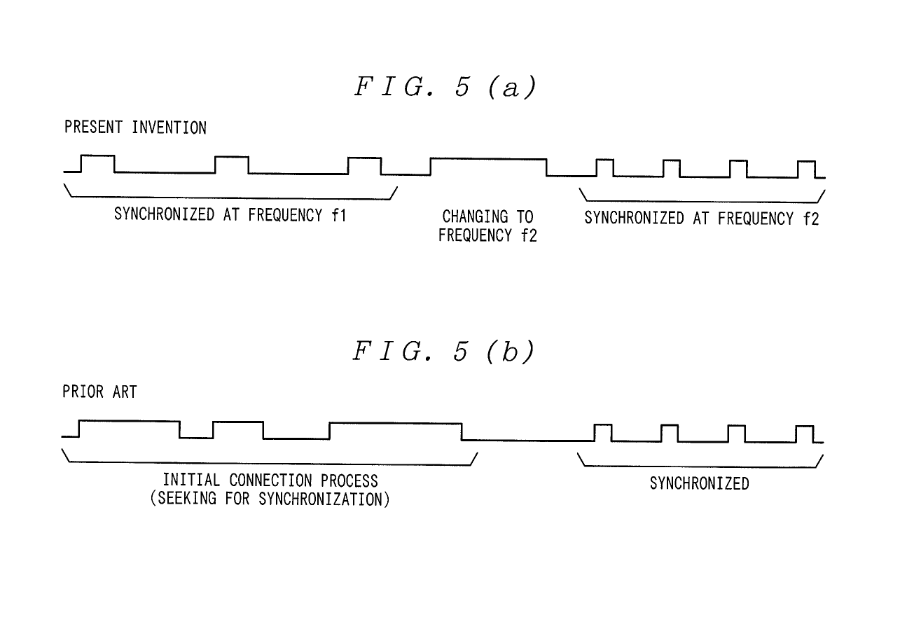

It is now assumed that a portable wireless communication device WC performs a wireless communication with another wireless communication device in a good communication environment where these devices are not affected by any disturbance wave such as an electromagnetic wave generated by a microwave oven, and that a control signal is used to secure the connection so that these devices are synchronized at a predetermined frequency f1 for data exchange as shown in FIG. 5(a). In this good communication environment, the frequency hopping controller 22 instructs to perform a predetermined frequency hopping pattern so that data transmission/reception can be effected by frequency hopping when the frequency of transmission data or received data falls within a preset normal frequency band of 2400 to 2500 MHz in the ISM band. For example, the frequency falls within a range of 2400 to 2483.5 MHz for the frequency hopping system or Bluetooth system commonly used in Europe and USA.

For this communication environment, when a signal is received with the transmitting/receiving antenna 1, an RSSI signal representing the level of the received signal supplied by the limiter amplifier 9 has a waveform corresponding to a necessary received signal transmitted by a communication partner, an unnecessary received signal transmitted by a wireless communication device other than the communication partner, or a narrow-band signal such as that for amateur radio or mobile unit identification as described later, that is, a single random waveform which has no period corresponding to the level of a received signal like a wave generated by a microwave oven.

Therefore, even when the RSSI signal is supplied to the comparator 29 in the disturbance wave detector 26 for comparison with a frequency-divided signal from the variable frequency dividing circuit 28, the two signals will not coincide with no resulting coincidence signal from the comparator 29. Thus, the variable frequency dividing circuit will repeat a frequency dividing operation on a master clock MC supplied by the master clock signal oscillation circuit 27 with a predetermined range of frequency dividing ratios from smaller to larger and the period determination circuit 30 will provide no radiation period signal. The frequency hopping will be also repeated within a normal frequency band preset by the frequency hopping controller 22 for normal data transmission/reception. Although an amateur radio or mobile unit identification (only in Japan) system is a narrow-band communication system which occupies a narrower bandwidth, a frequency hopping system may be unlikely to be subject to interference of such a system. In this respect, only if these systems coexist satisfactorily, such an environment can be considered good.

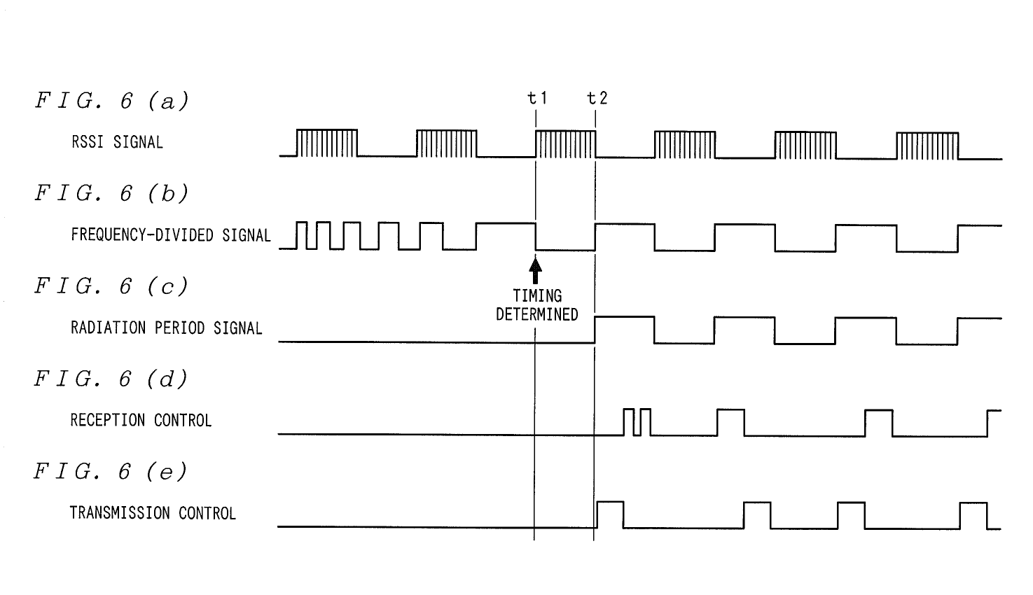

When a user carrying a portable wireless communication device WC leaves such a good communication environment and moves into an interference region around an operating inverter-type microwave oven or actuates a halting microwave oven within an interference region around an inverter-type microwave oven, an electromagnetic wave generated by the microwave oven is received with the receiving antenna as a disturbance wave and thus, the device is placed into a disturbance wave received state. Then, an RSSI signal provided by the limiter amplifier 9 in the receiving circuit 3 will contain a burst signal with a constant period as shown in FIG. 6(a) due to the electromagnetic wave generated by the microwave oven and this signal will be supplied to the comparator 29. Since a frequency-divided signal with a gradually increasing frequency dividing ratio as shown in FIG. 6(b) is supplied by the variable frequency dividing circuit 28 to the comparator 29, a phase difference between the two signals is adjusted so that the frequency-divide signal in the variable frequency dividing circuit 28 trails at the leading edge of the burst signal. Consequently, when the periods of the burst signal and the frequency-divided signal coincide at time t1, a coincidence signal is supplied by the comparator 29 to the variable frequency dividing circuit and the period determination circuit 30.

Thus, when the coincidence signal is supplied to the variable frequency dividing circuit 28, the frequency dividing ratio used therein is fixed to a current one to provide a frequency-divided signal which is synchronized 180 degrees out of phase with the burst signal. Then, the period determination circuit 30 will provide it as a radiation period signal as shown in FIG. 6(c) to the received data processor 21, the frequency hopping controller 22, and the transmission data processor 23, at time t2 subsequent to time t1.

The frequency hopping controller notifies the communication partner that the frequency f1 of a control signal to keep the communication connection established will be changed to a predetermined frequency f2 within a band of 2.475 to 2.497 GHz which is used for the wireless LAN and unaffected by any electromagnetic wave from a microwave oven. Then, the frequency hopping controller changes the frequency of the control signal to the predetermined frequency f2 as shown in FIG. 5(a) for synchronization at the predetermined frequency f2 and transmits an electromagnetic wave radiation period to the communication partner by means of the control signal.

Since the frequency of the control signal is shifted into the frequency band unaffected by any electromagnetic wave from a microwave oven, the communication connection will be kept established by the control signal without interception and there is no need to perform a reconnect communication connection operation which involves a larger power consumption, thereby reducing the power consumption of the device.

In contrast, according to the third prior art described above, when affected by a disturbance wave such as an electromagnetic wave generated by a microwave oven, the master station accesses the communication management server through a wired system to switch to a hopping pattern which may avoid disturbance and then attempts to reconnect with the slave station for resuming the communication. Therefore, as shown in FIG. 5(b), an initial connection process is performed to seek for synchronization and then the system is placed in a synchronized state. Since the system restarts at the initial connection process every time it is affected by a disturbance wave, the internal power supply 24 will be substantially consumed to reduce its communication time. However, the present invention can solve this disadvantage.

The received data processor 21 and the transmission data processor 23 perform a receiving process for received data and a transmitting process for transmission data, respectively, as shown in FIG. 6(d), while the radiation period signal supplied by the period determination circuit 30 is in the ON state, that is, while no electromagnetic wave is radiated by the microwave oven.

Thus, the present device performs the exchange of transmission data and received data to the extent that its received wave is not affected by any disturbance wave such as an electromagnetic wave generated by the microwave oven, so that its wireless communication can be secured.

When the device is in the disturbance wave received state, the radiation period signal is also supplied to the power controller 25 to suppress the power consumption of the receiving circuit 3, the transmitting circuit 4, and the frequency synthesizer 15 while the radiation period signal is in the OFF state and the device is affected to any disturbance wave from the microwave oven. This allows the device to communicate for a longer period of time on the internal battery 24. Similarly, since the communication partner is notified of the electromagnetic wave radiation period, the power consumption for the receiving circuit, the transmitting circuit, and the frequency synthesizer in the partner s device can be also suppressed during the electromagnetic wave radiation period.

Moreover, for example, in a situation where electromagnetic waves are generated by a plurality of microwave ovens, when the wireless communication with the communication partner is hindered, the power supply to the receiving circuit 3, the transmitting circuit 4, and the frequency synthesizer 15 can be stopped to suppress an unnecessary power consumption.

In this way, according to the above-mentioned embodiment, the frequency dividing ratio of a master clock MC is gradually increased by the variable frequency dividing circuit 28 so that the master clock may coincide with the RSSI signal supplied by the limiter amplifier 9 in the receiving circuit 3. Thus, a periodic disturbance wave from the microwave oven can be accurately detected without use of the commercial power. In addition, even when the user moves from an area where a commercial power frequency of 50 Hz is used to another area where a commercial power frequency of 60 Hz is used and vice versa, and hence, a difference in commercial power frequency may cause the microwave oven to generate an electromagnetic wave of a different period, the periodicity can be accurately determined in an automatic manner.

The baseband signal processor 11 is implemented in hardware according to the above-mentioned embodiment but the present invention is not limited to this implementation and may be implemented by using a microcomputer to perform the above-mentioned operation in software.

The disturbance wave detector 26 is constituted by the variable frequency dividing circuit 28, the comparator 29, and the period determination circuit 30 according to the above-mentioned embodiment but the present invention is not limited to this implementation and may be configured to perform an envelope detection on the burst signal from an electromagnetic wave generated by the microwave oven to produce a square-wave signal, based on which it is determined whether the wave has a periodicity, and to invert the square-wave signal into a radiation period signal if any periodicity is detected.

Data transmission/reception between wireless communication devices has been described above with reference to the above-mentioned embodiment but the present invention is not limited to this situation and may be applicable to broadcast communication to a plurality of communication partners. In the latter case, when a radiation period of a disturbance wave from a microwave oven is detected on the transmitter end, transmission means to notify of the occurrence and radiation period of the disturbance wave can be provided to cause a receive-only wireless communication device to recognize a fault on the communication line even when the receive-only wireless communication device is not affected by the disturbance wave from the microwave oven. This can stop the operation of the receiving circuit during a radiation period of time while the receive-only wireless communication device is consuming a power in a standby state, thereby further reducing the power consumption.

As described above in detail, a disturbance component which may affect the device's wireless communication signal such as an electromagnetic wave radiated by a microwave oven is extracted by the disturbance component extracting means from a signal received by the receiving antenna, the radiation period of the extracted disturbance component is accurately detected by the disturbance wave periodicity detecting means by comparing the disturbance component with a frequency-divided signal obtained at a gradually varying frequency dividing ratio with respect to a clock signal of a predetermined frequency, and then the exchange of a communication packet is performed by the communication control means during the radiation-free period of time based on the detected radiation period of the disturbance component, so that any effect of the disturbance wave can be avoided to secure the wireless communication.

Further, the frequency dividing circuit generates a frequency-divided signal with a gradually increased frequency dividing ratio with respect to a clock signal of a predetermined frequency and then the period determination circuit compares the frequency-divided signal with a signal received by the receiving antenna to determine the radiation period accurately synchronized with the disturbance component.

Further, when the disturbance wave periodicity detecting means detects the radiation period of a disturbance wave, the communication connection continuing means in the communication control means shifts the transmission frequency of a control signal to keep the communication connection established into a frequency band with no effect of the disturbance wave generated by a microwave oven or the like so that the communication connection can be kept established and any reconnect operation which may involve a larger power consumption can be avoided.

Further, even a communication partner who is out of the range of disturbance from the microwave oven can recognize a fault on the communication line, and for example, a receive-only terminal for receiving some broadcast information may consume a power in a standby state but it can recognize a fault and stop the receiving circuit only during a radiation period of time, thereby further reducing the power consumption.

Further, when the periodicity of a disturbance wave such as an electromagnetic wave generated by a microwave oven is detected by the disturbance wave periodicity detecting means, the communication circuit is powered during the exchange of a communication packet but the power supply to the communication circuit is discontinued during the radiation of the disturbance wave with no communication packet exchanged, so that an unnecessary power consumption can be suppressed.

Further, an unnecessary power consumption can be suppressed by discontinuing the power control when a disturbance wave hinders the communication packet from being transmitted.

What is claimed is:

1. A wireless communication device driven by an internal power supply, comprising: disturbance component extracting means for extracting from a signal received by a receiving antenna a disturbance component which may affect the device's wireless communication signal; disturbance wave periodicity detecting means for detecting the radiation period by comparing the disturbance component extracted by said disturbance component extracting means with a frequency-divided signal obtained at a gradually varying frequency dividing ratio with respect to a clock signal of a predetermined frequency; and communication control means for performing the exchange of a communication packet during a radiation-free period of time within the radiation period detected by said disturbance wave periodicity detecting means.

2. The wireless communication device according to claim 1, wherein said disturbance wave periodicity detecting means comprises a frequency dividing circuit for gradually increasing a frequency dividing ratio with respect to an input clock signal of a predetermined frequency and a period determination circuit for determining the period of a disturbance wave by comparing a signal received by a receiving antenna with a frequency-divided signal from said frequency dividing circuit.

3. The wireless communication device according to claim 1 or 2, wherein said communication control means comprises communication connection continuing means for shifting the transmission frequency of a control signal to keep the communication connection established into a preset disturbance-free frequency band to continue the communication connection when the radiation period of a disturbance wave is detected by said disturbance wave periodicity detecting means.

4. The wireless communication device according to claim 1, wherein said communication control means comprises transmission means for notifying of the presence and period of a disturbance wave any communication partner which cannot detect the presence of the disturbance wave when the radiation period of a disturbance wave is detected by said disturbance wave periodicity detecting means.

5. The wireless communication device according to claim 1, comprising power control means for controlling the power depending on the radiation period of the disturbance wave detected by said disturbance wave periodicity detecting means.

6. The wireless communication device according to claim 5, wherein said power control means is configured to determine whether a communication packet can be transmitted when the radiation period of a disturbance wave is detected by said disturbance wave periodicity detecting means, and to discontinue the power control when the communication packet cannot be transmitted.

7. The wireless communication device according to claim 2, wherein said communication control means comprises transmission means for notifying of the presence and period of a disturbance wave any communication partner which cannot detect the presence of the disturbance wave when the radiation period of a disturbance wave is detected by said disturbance wave periodicity detecting means.

8. The wireless communication device according to claim 3, wherein said communication control means comprises transmission means for notifying of the presence and period of a disturbance wave any communication partner which cannot detect the presence of the disturbance wave when the radiation period of a disturbance wave is detected by said disturbance wave periodicity detecting means.

9. The wireless communication device according to claim 2, comprising power control means for controlling the power depending on the radiation period of the disturbance wave detected by said disturbance wave periodicity detecting means.

10. The wireless communication device according to claim 3, comprising power control means for controlling the power depending on the radiation period of the disturbance wave detected by said disturbance wave periodicity detecting means.

11. The wireless communication device according to claim 4, comprising power control means for controlling the power depending on the radiation period of the disturbance wave detected by said disturbance wave periodicity detecting means.
